(19) United States
(12) Patent Application Publication
(10) Pub. No.: US 2008/0134524 A1
(43) Pub. Date: Jun. 12, 2008

(54) Dual purpose electric puncher

(76) Inventor: Humberto Rodriguez, Wabash, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/635,867

(22) Filed: Dec. 9, 2006

(51) Int. Cl. B26F 1/02

(52) U.S. Cl. 30/362

(57) ABSTRACT

A dual electric puncher punches two or three holes without readjustment. The dual purpose electric puncher includes a housing, an activation button, a motor, a group of three punch assemblies, and a group of two punch assemblies. Three punches are aligned along one side of the platform, and two punches are aligned along the opposite side of the platform. A gap allowing paper access to three punches is from one side of the dual purpose electric puncher, and another gap allowing access to two other punches is from the other, opposing side of the puncher. All five punches are activated simultaneously by the activation button.

### TECHNICAL FIELD

The technical field of this disclosure is the hole punching devices, particularly, the electrically-driven hole punchers for sheet materials.

### BACKGROUND OF THE INVENTION

Punchers are used to punch holes in paper and other sheet materials, such as cardboard, leather, fabric, and plastics, usually in order to be able to bind these sheets in a binder. Most of the punchers are manually activated with a lever or a handle.

Nowadays, some of the punchers are pushbutton activated and electric motor driven. These punchers are commonly called electric punchers. The electric punchers are known for their convenience and ease of operation.

Versatility for use with different binders is an important requirement that the customer puts on punchers. There are several different binder standards. The most popular in the US are the three-hole binders where the distance between two adjacent rings is 4.25″ and the two-hole binders where the distance between binder rings is 2.75″. Numerous adjustable punchers are known to the art where the punching members are readjusted in order to switch from a three-hole punch to two-hole punch, and vice-versa.

In the US Patent Application ##20040244554 (filed on Dec. 9, 2004, allowed on Jun. 3, 2003) I disclose a dual purpose puncher that does not require re-adjustment. In this Application, the two-hole and three-hole punch assemblies are placed on the same platform where the two-hole punch assembly is positioned opposingly to the three-hole stationary punch assembly in such a way that a central arm of the press lever frame of the three-hole punch assembly passes between two arms of the press lever frame of the two-hole punch assembly.

Ease of operation is also an important requirement that the customer puts on punchers. The device of the US Patent Application #20040244554 has the drawback of being a manual puncher having two manually-operated handles. It would be of interest to many consumers to combine the versatility of a dual purpose puncher with the ease of operation of the electrical puncher.

### SUMMARY OF THE INVENTION

This invention fulfills the need for an electrically-activated, small footprint, combination two-and-three-hole puncher, hereinafter a dual purpose electric puncher. According to the present invention, the dual purpose electric puncher comprises a housing, an activation button depressably disposed on the housing, a motor, a group of three punch assemblies, and a group of two punch assemblies.

The housing encloses the group of three punch assemblies and the group of two punch assemblies. The group of three punch assemblies is aligned along one side of the platform, and the group two punch assemblies is aligned along the opposite side of the platform.

A gap allowing paper access to three punches is from one side of the dual purpose electric puncher, and other gap allowing access to two punches is from the other, opposing side of the puncher. The group of three punch assemblies and the group of two punch assemblies are activated simultaneously by the activation button.

### BRIEF DESCRIPTION OF THE DRAWINGS

FIG. 1 shows a perspective view of the preferred embodiment of a dual purpose electric puncher made in accordance with the present invention.

FIG. 2 shows an exploded view of preferred embodiment of the dual purpose electric puncher made in accordance with the present invention.

FIG. 3 shows a cross-section view of preferred embodiment the dual purpose electric puncher made in accordance with the present invention.

### DRAWINGS REFERENCE NUMERALS

1. dual purpose electric puncher
2. housing
3. activation button
4. motor
5. group of three punch assemblies
6. group of two punch assemblies
7. punch assembly
8. punch
9. gear train
10. upper housing portion
11. lower housing portion
12. false ceiling
13. three punch paper stop
14. two punch paper stop
15. gap
16. other gap

### DESCRIPTION OF THE PRESENTLY PREFERRED EMBODIMENT

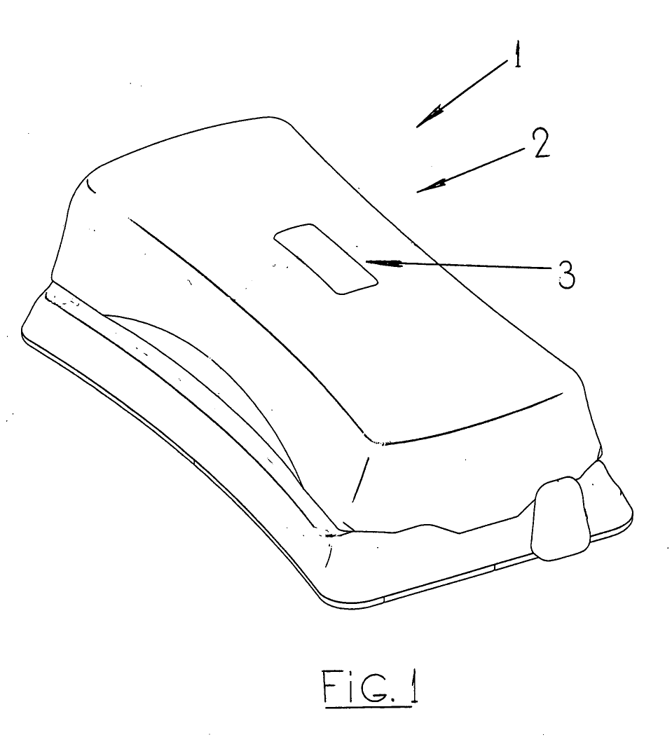

FIG. 1 shows a perspective view of the preferred embodiment of a dual purpose electric puncher 1 made in accordance with the present invention. The dual purpose electric puncher 1 comprises a housing 2 and an activation button 3. The activation button 3 is depressably disposed on the housing 2.

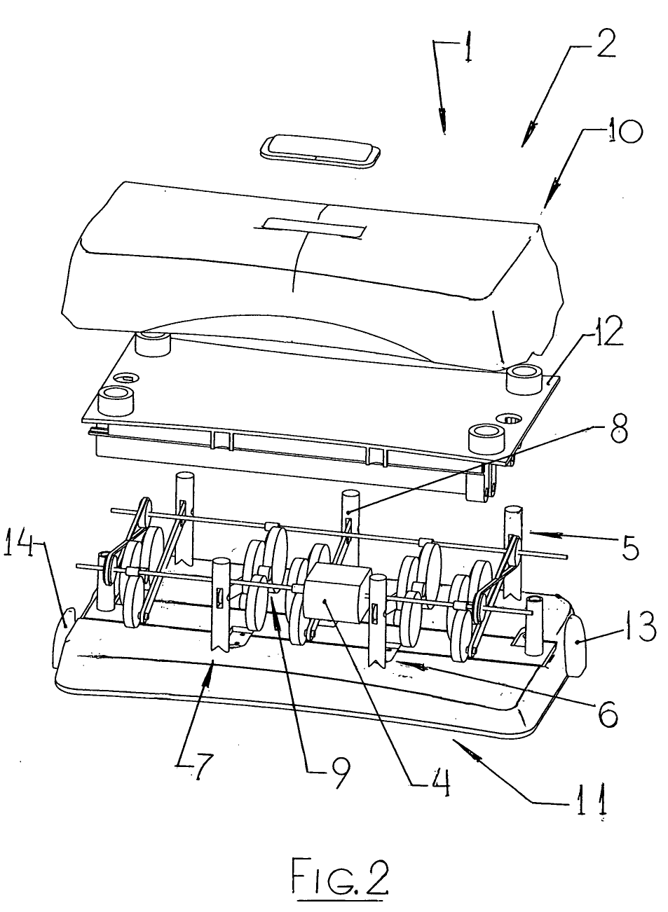

FIG. 2 shows an exploded view of preferred embodiment of the dual purpose electric puncher 1 made in accordance with the present invention. The dual purpose electric puncher 1 furthermore comprises a motor 4 driving a group of three punch assemblies 5 enclosed by the housing 2. The group of three punch assemblies 5 is aligned along one side of the housing 2.

The motor 4 is also driving a group of two punch assemblies 6, also enclosed by the housing 2. The group of two punch assemblies 6 is aligned along the opposite side of the housing 2.

As their names suggests, the group of three punch assemblies 5 and the group of two punch assemblies 6 are comprised of three and two punch assemblies 7 respectively.

The punch assembly 7 is comprised by a punch 8 urged to move up and down by a gear train 9. In-turn, the gear train 9 is urged to move by the motor 4.

The housing 2 is comprised of an upper housing portion 10 and a lower housing portion 11. The upper housing portion 10 fixedly supports the group of three punch assemblies 5 and the group of two punch assemblies 6. The upper housing portion 10 may include a false ceiling 12. The lower housing portion 11 may slidably support a three punch paper stop 13 and a two punch paper stop 14.

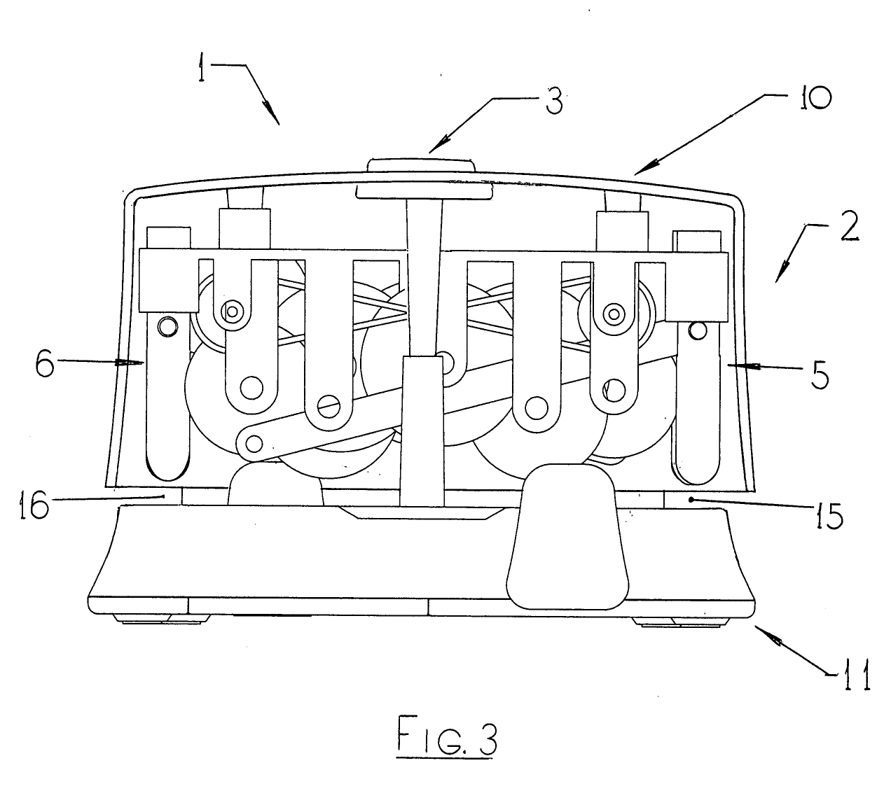

FIG. 3 shows a cross-section view of preferred embodiment of the dual purpose electric puncher 1 made in accordance with the present invention.

The upper housing portion 10 is fixedly disposed on the lower housing portion 11 forming a gap 15 between the upper housing portion and the lower housing portion. The gap 15 allows paper access to the group of three punch assemblies 5 from a side of the dual purpose electric puncher 1.

The upper housing portion 10 and the lower housing portion 11 form other gap 16 on an opposite side of the housing. The other gap 16 allows paper access to the group of two punch assemblies 6 from an opposite side of the dual purpose electric puncher 1.

The group of three punch assemblies 5 and the group of two punch assemblies 6 is activated simultaneously with the activation button 3.

The provided disclosure combines a three-hole electric puncher and a two-hole electric puncher in a single unit while utilizing the desk space in the most efficient manner.

1. A dual purpose electric puncher is claimed comprising:
a housing,
an activation button depressably disposed on said housing,
a motor,
a group of three punch assemblies, the group of three punch assemblies enclosed by said housing, said tree punch assemblies aligned along one side of said housing, and
a group of two punch assemblies, the group of two punch assemblies enclosed by said housing, said group of two punch assemblies aligned along the opposite side of said housing.

2. The dual purpose electric puncher of claim 1 wherein said housing is comprised of an upper housing portion and a lower housing portion.

3. The dual purpose electric puncher of claim 2 wherein said upper housing portion fixedly supports said group of three punch assemblies and said group of two punch assemblies.

4. The dual purpose electric puncher of claim 3 wherein said upper housing portion is fixedly disposed on said lower housing portion forming a gap between said upper housing portion and said lower housing portion on a side of said housing, whereby allowing paper access to said group of three punch assemblies from a side of said dual purpose electric puncher.

5. The dual purpose electric puncher of claim 4 wherein said upper housing portion and said lower housing portion form other gap on an opposite side of said housing, whereby allowing paper access to said group of two punch assemblies from an opposite side of said dual purpose electric puncher.

6. A method of puncher activation is claimed comprising steps of:
providing a dual purpose electric puncher comprising a housing, an activation button, a motor, a group of three punch assemblies, and a group of two punch assemblies, and
activating said group of three punch assemblies and said two group of two punch assemblies simultaneously with said activation button.
